(19) United States
(12) Patent Application Publication
(10) Pub. No.: US 2026/0154342 A1
(43) Pub. Date: Jun. 4, 2026

(54) Method, Device, Apparatus and Program Product for Graph Partitioning

(71) Applicant: HUAWEI TECHNOLOGIES CO., LTD., Shenzhen (CN)

(72) Inventors: Stanislav Vladimirovich Moiseev, Moscow (RU); Dmitry Valerievich Sirotkin, Moscow (RU); Anna Antonovna Mastikhina, Moscow (RU); Oleg Evgenievich Senkevich, Moscow (RU); Lijun Yu, Shenzhen (CN)

(73) Assignee: HUAWEI TECHNOLOGIES CO., LTD., Shenzhen (CN)

(21) Appl. No.: 19/391,321

(22) Filed: Nov. 17, 2025

Related U.S. Application Data
(63) Continuation of application No. PCT/RU2023/000148, filed on May 18, 2023.

(51) Int. Cl. G06F 16/901; G06F 16/2455

(52) U.S. Cl. CPC G06F 16/9024; G06F 16/24554

(57) ABSTRACT

A method includes that a finite projective plane is determined based on a number of partitions of a graph. The finite projective plane comprises a plurality of points and a plurality of lines, each point corresponding to one of the partitions and each line comprising a subset of the plurality of points. Based on vertices of an edge of the graph, a first line and a second line of the plurality of lines are determined. Based on the first line and the second line, a partition for the edge is determined. By assigning each edge to a corresponding partition, the graph is partitioned.

### CROSS-REFERENCE TO RELATED APPLICATIONS

This is a continuation of International Patent Application No. PCT/RU2023/000148, filed on May 18, 2023, which is hereby incorporated by reference in its entirety.

### FIELD

Embodiments of the present disclosure generally relate to the field of computer technology and in particular, to a method, a device, an apparatus, and a computer program product for graph partitioning.

### BACKGROUND

Large scale graph data, for example, where vertices representing documents, people, products, or other items are linked by edges, is generated in many application systems, for example, in social networking, information retrieval, video conferencing, product recommendation systems, knowledge management systems and others.

Existing approaches for querying graph data and carrying out computations using graph data in order to control application systems and others are typically time consuming and often do not scale up well to web-scale applications where massive amounts of data are involved. There is need for efficiently splitting large scale graph data into smaller graphs to be processed on computing devices.

The embodiments described below are not limited to implementations which solve any or all of the disadvantages of known ways of processing graph data.

### SUMMARY

In general, embodiments of the present disclosure provide a solution for graph partitioning.

In a first aspect, there is provided a method. The method comprises: determining, based on a number of partitions of a graph, a plurality of points and a plurality of lines in a finite projective plane, each point corresponding to one of the partitions and each line comprising a subset of the plurality of points; determining, based on vertices of each of a plurality of edges of the graph, a first line and a second line of the plurality of lines; identifying, based on the first line and the second line, a partition for each edge; and partitioning the graph by assigning each edge to a corresponding partition. In this way, a graph can be partitioned with a bounded replication factor and the performance for distributed graph processing is improved.

In a second aspect, there is provided an electronic device. The electronic device comprises a processor and a memory coupled to the processor, wherein the memory has instructions stored therein which, when executed by the processor, cause the device to perform actions. The actions comprise: determining, based on a number of partitions of a graph, a plurality of points and a plurality of lines in a finite projective plane, each point corresponding to one of the partitions and each line comprising a subset of the plurality of points; determining, based on vertices of each of a plurality of edges of the graph, a first line and a second line of the plurality of lines; identifying, based on the first line and the second line, a partition for each edge; and partitioning the graph by assigning each edge to a corresponding partition.

In a third aspect, there is provided an apparatus. The apparatus comprises: means for determining, based on a number of partitions of a graph, a plurality of points and a plurality of lines in a finite projective plane, each point corresponding to one of the partitions and each line comprising a subset of the plurality of points; means for determining, based on vertices of each of a plurality of edges of the graph, a first line and a second line of the plurality of lines; means for identifying, based on the first line and the second line, a partition for each edge; and means for partitioning the graph by assigning each edge to a corresponding partition.

In a fourth aspect, there is provided a computer program product tangibly stored on a computer-readable medium and comprising machine-executable instructions, wherein the machine-executable instructions, when executed, cause a machine to perform the method according to the first aspect of the present disclosure.

In a fifth aspect, there is provided a computer-readable medium comprising machine-executable instructions, wherein the machine-executable instructions, when executed, cause a machine to perform the method according to the first aspect of the present disclosure.

It is to be understood that the Summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Some embodiments will now be described with reference to the accompanying drawings, where:

FIG. 1 illustrates a schematic diagram of an example environment in which a plurality of embodiments of the present disclosure can be implemented;

FIG. 2 illustrates a flowchart of an example method for partitioning a graph according to some embodiments of the present disclosure;

FIG. 3 illustrates a schematic diagram of an example workflow for partitioning a graph based on a finite projective plane according to some embodiments of the present disclosure;

FIG. 4 illustrates an example graph for partitioning according to some embodiments of the present disclosure;

FIG. 5 illustrates a schematic block diagram of a device that can be used to implement embodiments of the present disclosure.

Throughout all the drawings, the same or similar reference numerals represent the same or similar elements.

### DETAILED DESCRIPTION

The principle of the present disclosure will now be described with reference to some embodiments. It is to be understood that these embodiments are described only for the purpose of illustration and to help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of the ordinary skills in the art to which this disclosure belongs.

References in the present disclosure to “one embodiment,” “some embodiments,” “an embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with some embodiments, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of embodiments. As used herein, the term “and/or” includes any and all combinations of one or more of the listed terms.

The terminology used herein is for the purpose of describing particular embodiments only and is not intended to be limiting to embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components, etc., but do not preclude the presence or addition of one or more other features, elements, components and/or combinations thereof.

For better understanding embodiments of the disclosure, provided below are definitions of related terms that are mentioned in the disclosure.
Graph: the pair of sets (V, E), V is the set of vertices, E is the set of pairs of vertices (v, u)—edges; v is called source, u is called destination.
Subgraph: of graph G=(V, E): graph G′=(V′, E′) such that V′⊆V, E′⊆E.
Graph Partition: distributing graph elements to the smaller set. There are two types: vertex partition and edge partition, the latter case is considered in this disclosure. For example, given an input value n—number of partitions—each edge receives integer number from 0 to n−1.
Replication factor: average number of vertex replicas that is equal to the summarized number of vertices in all subgraphs V(Eᵢ) formed by partitions Eᵢ, i=0, . . . , n−1, divided by number of vertices |V|:

$${\sum }_{i = 0}^{n - 1} \frac{\vert V ( {E}_{i} ) \vert}{\vert V \vert}$$

It shows how much vertices are duplicated.
Balance: maximal number of edges on one partition divided by average number of edges on one partition; better balance should be close to 1.0:

$$\frac{{max}_{i} \vert {E}_{i} \vert}{\vert E \vert / n}$$

Projective plane: a set of lines, a set of points and relation between points and lines called incidence having the following properties:
   given any 2 distinct points, there is exactly 1 line incident with both of them;
   given any 2 distinct lines there is exactly 1 point incident with both of them;
   there are 4 points such that no line is incident with more than 2 of them.
Finite field Fq: finite set of q elements with two associative and commutative operations (+ and ·) which satisfy the following rules:
   1. There is 0 and 1 in F_{q} (0≠1) such that 0+a=a, 1·a=a for every a∈F_{q}.

$$a \cdot ( b + c ) = a \cdot b + a \cdot c for every a , b , c ∈ {F}_{q} . \qquad 2.$$

3. For every a∈F_{q} there is b∈F_{q} such that a+b=0.
4. For every a∈F_{q} such that a≠0 there is c∈F_{q} such that a·c=1
Finite projective plane: projective plane over field F_{q}.

The graph partitioning problem is a computational task of graph elements' distribution to smaller disjoint sets. Graph partitions can be performed as vertex partitions and edge partitions. In this disclosure, the latter case is considered. Input of a graph partitioning system is graph represented as the set of edges and the number of partitions n. The result of the system is partitioned graph, which means that every edge corresponds to the number from 0 to n−1.

Graph partitioning is an important step in distributed computations. This task is essential for the analysis of the large graphs due to large runtime. In practice, graphs are distributed on several machines in some way in order to optimize storage but also it can significantly speed up the computation. The way graph is partitioned influences critically on the load balance, on the amount of interactions between the machines which is important for the runtime. Unfortunately, the ideal separation of the graph between machines without any data duplication is in the most cases impossible.

After edge partition is performed some vertices are “cut”—they appear on different partitions. When such vertices are affected in the algorithms there is interaction between different machines. To make algorithm performance faster, it makes sense to reduce number of repeating vertices; average number of vertex replicas is called replication factor.

There are a lot of partitioning methods in articles and frameworks which, being applied to some graph algorithm, show runtime acceleration. There are investigations concerning graph partition quality metrics such as balance and replication factor. Methods and algorithms usually aim to optimizing these metrics. But such improvements highly depend on graph structure and target application that needs to be accelerated. There is no universal method for all cases. In addition, partitioning methods which achieve better partition quality usually use more complex calculations and so could be time consuming. High partition time is essential in the task where partition is performed before each application run. That's why complicated graph partitioning methods cannot be used in scenarios where partition is part of the whole computation pipeline.

Some methods guarantee the partition has a bounded replication factor. For example, the EdgePartition2D method which is usually considered as baseline has a replication factor less than 2\sqrt{n}−1, where n is a number of partitions. Another method called torus-based partition may have a maximal replication factor r≈1.5\sqrt{n}+1, which is less than the approximate replication factor for EdgePartition2D. However, those methods cannot obtain the theoretical bound (\sqrt{n} for the complete graph).

The existing partition methods which achieve better partition quality usually use more complex calculations and so can be time consuming. High partition time is essential in the task where partition is performed before each application run. That's why complicated graph partition algorithms cannot be used in scenarios where partition is part of the whole computation pipeline. In addition, the replication factor doesn't reach lower possible bound.

In view of this, there is provided an approach for partitioning a graph based on a finite projective plane. In this approach, a computing device creates a finite projective plane based on a number of partitions n. The finite projective plane comprise n points each corresponding to a partition of graph, and n lines each consist of a subset of the points in the finite projective plane. Regarding each edge of a graph to be partitioned, the computing device maps two vertices of the edge to two lines, and determine a point in the finite projective plane based on the two lines. The computing device then the edge to the corresponding partition. By assigning all edges of the graph to corresponding partitions, the device generates partitioned graph. In this way, a graph can be partitioned with reduced time, and an improved bound of replication factor is achieved.

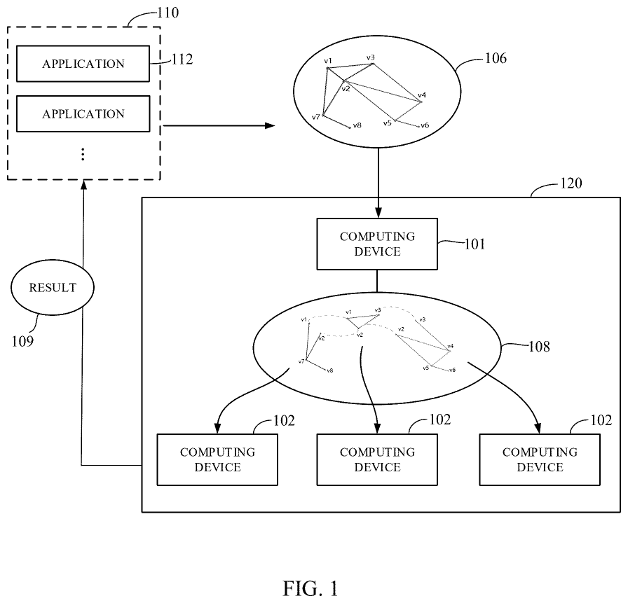

Principles and embodiments of the present disclosure will be described in detail below with reference to the accompanying drawings. Reference is first made to FIG. 1, which illustrates a schematic diagram of an example environment 100 in which a plurality of embodiments of the present disclosure can be implemented.

The example environment 100 includes an application system 110 and a distributed computer system 120. The distributed computer system 120 includes a plurality of computing devices 101 and 102 which may be arranged at same or different geographic locations. In the distributed computer system 120, a computing device 101 is coupled to an application system 110 and configured to perform graph partitioning methods.

The computing device 101 takes as input the graph 106 comprising a plurality of edges each represented by a pair of vertices. The graph 106 may be a directed graph where some of the edges have directions. The graph 106 may be an undirected graph where none of the edges has a direction. In both cases, each of the edges may be represented by a source (src) vertex and destination (dst) vertex. The vertices of the graph 106 have identities. The identities of vertices may comprise one or more of numbers, strings, characters, and the like. The computing device 101 may receive or access the graph 106 as a data stream from the application system 110 to be controlled or influenced using the graph. In some examples the graph may be stored (at the computing device 101 or elsewhere). The computing device 101 may partition the graph 106 into subgraphs 108 and distribute subgraphs 108 to computing devices 102 associated with graph analytics applications.

The application system 110 may comprise a plurality of applications 112 to be controlled or influenced using the graph 106. The application system 110 may be any computer implemented system which observes and/or records events that may be recorded as one or more connections between items represented as graph vertices. Depending particular applications, each graph vertex may represent at least one item, such as a person, product, document, email account, video conference account, or other item. Each graph edge represents a relationship between items represented by the vertices it connects.

For example, one of the applications 112 may be a social network system which stores user accounts and enables connections to be made between user accounts and/or communications to be sent between user accounts. In this case the graph 106 may be a social graph where operations are user interactions, defined through social engagements represented with graph edges. The applications 112 may be an information retrieval system which obtains addresses of documents or other items and information about links or other connections between the documents. The documents may be represented using graph vertices and the links between documents may be represented as edges. The applications 112 may be a video conferencing system which represents video conferencing accounts associated with people by graph vertices. Communication events between users of the video conferencing system may be represented using graph edges. The application 112 may be a recommendation system which uses features of users and products in order to recommend products to users. For example, a graph vertex may represent a user and/or a product and the edges may represent events such as whether a user has purchased a given product. The system may be a knowledge management system. For example, the graph may be a knowledge graph where vertices represent people, places and items and edges represent relationships such as “likes”, “dislikes”, “lives”, or “works”.

Once the graph 106 is available it is possible to use the graph 106 to control the application system 110. For example, queries on the graph 106 may yield results which are used to improve information retrieval results, improve recommendations, suggest new friends in social networks and for other purposes. However, for many situations the scale of the graph 106 is so massive that it is not practical to carry out computations on the graph data in practical time scales.

As mentioned, the graph 106 may be partitioned into subgraphs 108 whereby the subgraphs 108 are smaller in size than the overall graph 106. Each subgraph may be stored at, or accessible to, one or more computing devices 102 at a data center or distributed at various locations and in communication with one another. Computations may be carried out at the individual computing devices 102 and the results aggregated so as to enable massive scale graph data to be accommodated. For example, queries on the graph data may be large and each query may be carried out on many of the clusters. Computation results 109 may be sent to the application system 110 and used to control that system.

In some embodiments, the computing devices 101 and 102 can be implemented as various user terminals or service terminals having the computing capability. The service terminals can be servers, large-scale computing devices, and the like provided by a variety of service providers. The user terminal may be, for example, a mobile terminal, a fixed terminal, or a portable terminal of any type, including a mobile phone, a site, a unit, a device, a multimedia computer, a multimedia tablet, an Internet node, a communicator, a desktop computer, a laptop computer, a notebook computer, a netbook computer, a tablet computer, a Personal Communication System (PCS) device, a personal navigation device, a Personal Digital Assistant (PDA), an audio/video player, a digital camera/video, a positioning device, a television receiver, a radio broadcast receiver, an electronic book device, a gaming device or any other combinations thereof, including accessories and peripherals of these devices or any other combinations thereof. It can also be appreciated that the computing devices 101 and 102 can support any type of user-specific interfaces (such as “wearable” circuits and the like).

Alternatively, or in addition, the functionality of the computing devices 101 and 102 described herein can be performed, at least in part, by one or more hardware logic components of an electronic device. For example, and without limitation, illustrative types of hardware logic components that can be used include field-programmable gate arrays (FPGAs), application-specific integrated Circuits (ASICs), application-specific standard products (ASSPs), system-on-a-chip (SOCs), complex programmable logic devices (CPLDs), graphics processing units (GPUs).

It is to be understood that the architecture and functions in the environment 100 are described for illustrative purposes only without suggesting any limitations. There may also be other devices, systems, or components that are not shown in the environment 100. Furthermore, embodiments of the present disclosure may also be applied to other environments having different structures and/or functions.

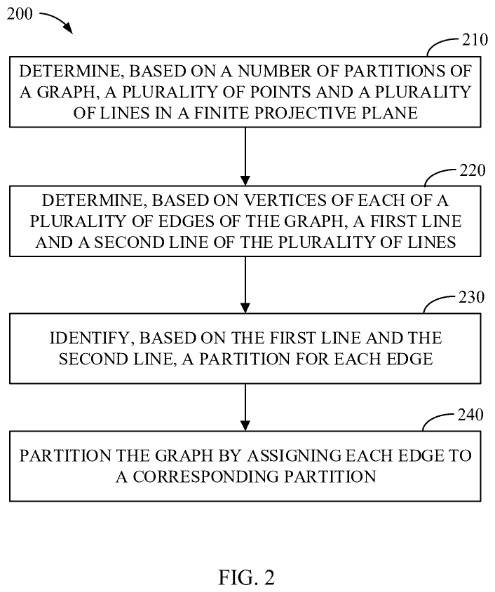

Reference is now made to FIG. 2 which illustrates a flowchart of an example method 200 for partitioning a graph according to some embodiments of the present disclosure. The example method 200 may be performed, for example, by the computing device 101 shown in FIG. 1. It should be understood that the method 200 may also include additional actions not shown, and the scope of the present disclosure is not limited in this regard. The method 200 is described in detail below in conjunction with the example environment 100 of FIG. 1.

At block 210, the computing device 101 determines, based on a number of partitions of a graph, a plurality of points and a plurality of lines in a finite projective plane. In the finite projective plane, each point may correspond to one of the partitions and each line may comprise a subset of the plurality of points.

In some embodiments, the number of the points and a number of the lines are equal to the number of the partitions. Let n denote the number of partitions. The finite projective plane may comprise n points, as a whole represented by S, and n lines, each represented by Sᵢ, i=0 . . . n.

In some embodiments, the number of partitions n may be a value of an irreducible polynomial of a prime power. For example, n=p^{2k}+p^{k}+1, where p is a prime number, and k is a positive integer. In some embodiments, the computing device 101 may receive an input number N indicating a desired number of partitions by the user. If N is not a value of an irreducible polynomial of a prime power, the computing device may determine an appropriate number of partitions n based on the input number N. For example, n may be a maximal number in form of p^{2k}+p^{k}+1, but equal to or less than the input number N. In this case, Results for the number of partitions n=p^{2k}+p^{k}+1 and any n<(p+1)^{2k}+(p+1)^{k}+1 are the same.

To create the finite projective plane, the computing device 101 obtains the prime number p and the integer k according to the irreducible polynomial, such as n=p^{2k}+p^{k}+1. For p and k, the computing device 101 may find the points S of the finite projective plane. In some embodiments, each point may be represented as an array with 3 elements of finite field F having an order of the prime number q=p^{k}. In some embodiments, each element of a point may be represented by a number from 0 to q−1.

In some embodiments, the computing device 101 may find the lines or the subset of the points such that Sᵢ∩Sⱼ≠Ø for any i and j. The graph partitioning may look like this. Consider a mapping function from vertices to the lines of the projective plane ψ: V→{Sᵢ}. For the edge(u, v), consider two subsets: ψ(u) and ψ(v). The subsets have non-empty intersections, and a partition may be chosen for this edge from this intersection. In some embodiments, the indexes of the subsets or lines may be a function ψ of identities (IDs) of two vertices of the edge. The function ψ may be, for example, the remainder of division vertex Id by the whole part of the number of partitions: ψ(v)=v % n.

In some embodiments, each line may be defined by one of the points such that all points in the line has a scalar product equal to zero with that point. For example, each line may be defined by the point u, it is all the points v such that u·v=0 which is scalar product.

In some embodiments, the partitioning takes projective plane as the point set S, points may correspond to the indices of partitions, subsets Sᵢ are lines on this plane. As mentioned, the number of subsets or lines may be equal to the actual number of partitions n=p^{2k}+p^{k}+1, where p is prime number. Since subsets Sᵢ are lines on projective plane, the intersection of two (different) subsets contains exactly one point. Each vertex corresponds to some subset (mapping ψ: V→{Sᵢ}). Also, each of the subsets or lines of the projective plane consists of the primer power plus one, i.e. p^{k}+1 points, so any vertex can't be replicated more than p^{k}+1 times (or else in all intersections of correspondent Sᵢ with other subsets there are more points than p^{k}+1 which is wrong). Note that p^{k}+1≈\sqrt{p^{2k}+p^{k}+1}=\sqrt{n}. That guarantees replication factor not greater than \sqrt{n}.

In some embodiments, the finite projective plane including the points and lines may be created only based on the number of partitions. The computing device 101 may create the finite projective plane offline without an actual input of graphs. In this way, partitioning time may be further reduced.

At block 220, the computing device 101 determines, based on vertices of each of a plurality of edges of the graph, a first line and a second line of the plurality of lines. For a given edge (u, v), the computing device 101 may map the vertices of the edge separately to a line of the projective plane using function V→{Sᵢ}, as above described. Thus, the computing device obtains a first line and a second line.

At block 230, the computing device 101 identifies, based on the first line and the second line, a partition for each edge. The computing device 101 may determine a point in the finite projective plane based on the first line and the second line, and determine for the edge a partition corresponding to the point.

As mentioned, interaction of two different lines of the finite projective planes contains exactly one point. In some embodiments, if the first line and the second line are different lines, the computing device 101 may determine the point for partition as the intersection of the first line and the second line. If the first line and the second line are the same line, that is, two vertices of the edge are mapped to the same line or subset, the intersection of the two lines comprises multiple points of the line. In this case, the computing device 101 may determine the point for partition as in a point in the line based on a mapping from a line to a point in that line: φ: {Sᵢ}→S, such that φ(Sᵢ)∈Sᵢ. In some embodiments, the mapping φ may be formed by Kuhn algorithm. This removes random choice keeping all method advantages, and can improve balance in the result of the current method. In this way, the computing device 101 determines intersections of the plurality of lines for different lines, and determines points corresponding to the lines respectively based on the line to point mapping φ. In some embodiments, the computing device 101 may store intersections and points in association with the plurality of lines, for example, in form of a matrix called intersection matrix.

At block 240, the computing device 101 partitions the graph by assigning each edge to a corresponding partition. The computing device 101 may associates the identity information of the partition with the edge to include the edge in the corresponding partition. By processing each and every edge in the graph, the graph is partitioned into a set of subgraphs. In some embodiments, the computing device 101 may distribute the partitioned graph, i.e. the subgraphs to multiple computing devices 102. The computing devices 102 perform graph algorithms with the subgraphs. Note that the computing device 101 may perform the actions in blocks 220, 230, and 240 sequentially or in parallel to improve performance of graph partitioning.

The solution for partitioning a graph in accordance with embodiments of the disclosure has been described above with reference to FIGS. 1 to 2. The solution uses lines on a finite projective plane as subsets of points corresponding to partitions. In comparison to other methods, it reduces processing time of partitioning and guarantees that replication factor is bounded by V, where n is number of partitions, reducing graph processing time as well. In some embodiments, it also removes random choice keeping all method advantages and improves balance in the results.

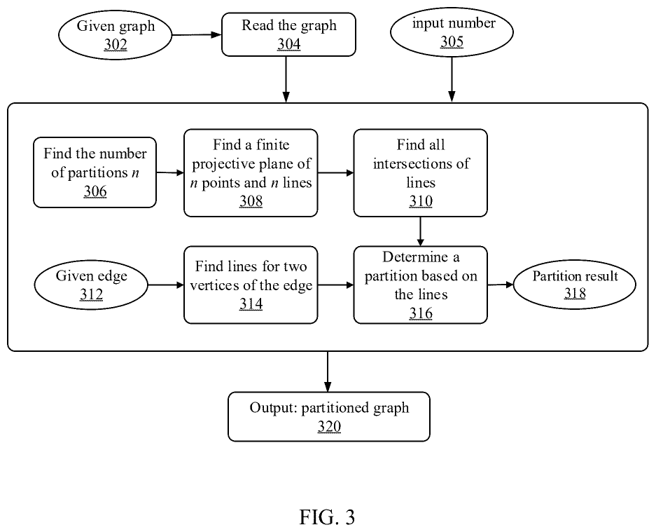

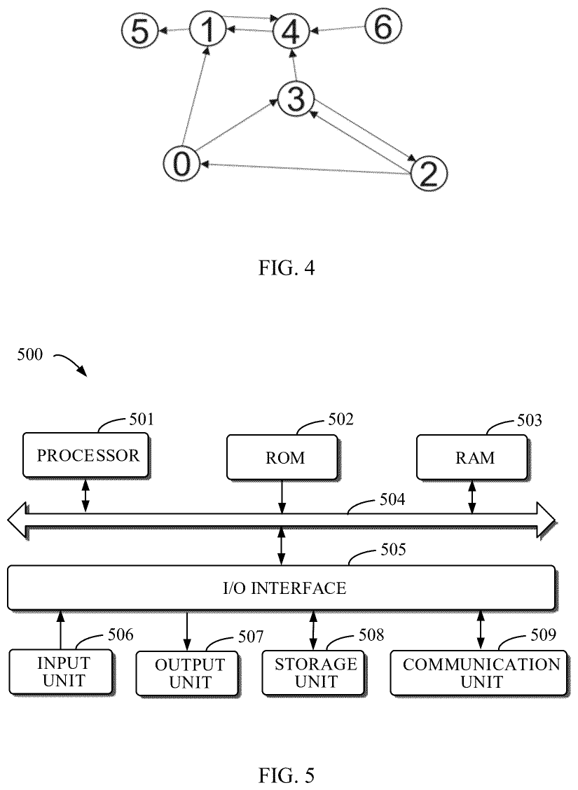

FIG. 3 illustrates a schematic diagram of an example workflow for partitioning a graph based on a finite projective plane according to some embodiments of the present disclosure. The work follow may be implemented on the computing device 101 in FIG. 1. In FIG. 3, a graph is considered as the set of vertices and edges, where an edge is an ordered pair of vertices. A partitioned graph is the set of edges where each edge has an index meaning partition to which it belongs.

A given graph 302 is represented as a set of edges. Another input parameter is the input number (N) 305 of partitions, which may be desired by the user. At block 304, after reading the given graph into memory the following operations are performed.

At block 306, find an actual number of partitions n and related prime power q=p^{k} based on the input number N. In some embodiments, it may first find the prime power q based on the input parameter N. The prime power may be a maximal q=p^{k} for some prime number p and natural number k that N≥q²+q+1. Then, the actual number of partitions may be set as n=q²+q+1. Other irreducible polynomials are applicable.

At block 308, find a finite projective plane S of n points and n projective lines Sᵢ on it. The input of block 308 may comprise the actual number of partitions n and prime power q. The output may comprise points represent as Array[Array[Int]] of the size n and lines represented as Array[Array[Int]] of the size. To find all points, each point is an array of size 3 (x₁, x₂, x₃), with elements of finite field [symbol] of order q, and each element xᵢ, i=1,2,3, of the field [symbol] is represented as an array xᵢ=(a₀, . . . , aₖ₋₁) of size k (it can be considered as polynomial a₀+a₁x+ . . . +aₖ₋₁x^{k-1}). Some examples are described as below.

### Example 1

$$q = 2 , p = 2 , k = 1.$$

[symbol] ≅ [symbol] , elements {0,1}.
Let find points (7=4+2+1).
These are 1-dimensional lines in 3-dimensional space V over filed [symbol] .
1 point (0, 0, 1)
2 points with coordinates (0, 1, a): {(0, 1, 0), (0, 1, 1)}
4 points with coordinates of the form (1, a, b): {(1, 0, 0), (1, 1, 0), (1, 0, 1), (1, 1, 1)}

### Example 2

$$q = 4 , p = 2 , k = 2$$

Irreducible polynomial x²+x+1, α—its root in [symbol] , generating element of multiplicative group {0, 1, α, α+1} which is {(0,0), (1,0), (0,1), (1,1)}.
Let find points (there are 21=16+4+1 of them).
These are 1-dimensional lines in 3-dimensional space V over filed [symbol] .
1 point ((0,0), (0,0), (1,0)).
4 points with coordinates ((0,0), (1,0), a): {((0,0), (1,0), (0,0)), ((0,0), (1,0), (1,0)), ((0,0), (1,0), (0,1)), ((0,0), (1,0), (1,1))}.
16 points with coordinates of the form ((1,0), a, b): {((1,0), (0,0), (0,0)), ((1,0), (0,0), (1,0), . . . , ((0,0), (1,1), (1,1))}

Then, find all projective lines. Each line may be represented as 2-dimensional subspace of 3-dimensional vector space over finite field [symbol] . Each line may be defined by the point u, it is all the points v such that u·v=0 which is scalar product over [symbol] . An example is described as below.

### Example 3

Consider points from Example 1.
Line is defined by homogeneous equation (there are q²+q+1=7 such equations) and consists of 3=q+1 points.

$${u}_{1} = 0 , {S}_{0} = \{ ( 0 : 1 : 0 ) , ( 0 : 1 : 1 ) , ( 0 : 0 : 1 ) \}$$

$${u}_{1} + {u}_{3} = 0 , {S}_{1} = \{ ( 1 : 0 : 1 ) , ( 1 : 1 : 1 ) , ( 0 : 1 : 0 ) \}$$

$${u}_{1} + {u}_{2} = 0 , {S}_{2} = \{ ( 1 : 1 : 0 ) , ( 1 : 1 : 1 ) , ( 0 : 0 : 1 ) \}$$

$${u}_{1} + {u}_{2} + {u}_{3} = 0 , {S}_{3} = \{ ( 1 : 0 : 1 ) , ( 1 : 1 : 0 ) , ( 0 : 1 : 1 ) \}$$

$${u}_{2} = 0 , {S}_{4} = \{ ( 1 : 0 : 0 ) , ( 1 : 0 : 1 ) , ( 0 : 0 : 1 ) \}$$

$${u}_{2} + {u}_{3} = 0 , {S}_{5} = \{ ( 1 : 0 : 0 ) , ( 1 : 1 : 1 ) , ( 0 : 1 : 1 ) \}$$

$${u}_{3} = 0 , {S}_{6} = \{ ( 1 : 0 : 0 ) , ( 1 : 1 : 0 ) , ( 0 : 1 : 0 ) \}$$

where u₁, u₂, u₃ denote elements of a point, and Sᵢ, i=0 . . . 6, denote the lines.

At block 310, find all intersections Sᵢ∩Sⱼ. Input of block 310 may comprise subsets (represented as Array[Array[Int]] of the size n; it is array of projective lines; line is an array of q+1 points). The output of block 310 may comprise intersections (represented as Array[Array[Int]] of the size n, it can be considered as intersection matrix n×n; element intersections(i)(j) contains intersection of Sᵢ and Sⱼ; element which corresponds to i-th subset is kept in i-th diagonal element of intersections matrix). The following statement takes place:

$$\vert {S}_{i} ⋂ {S}_{j} \vert = 1 if i \neq j and \vert {S}_{i} ⋂ {S}_{j} \vert = q + 1 if i = j .$$

The latter case occurs when v % n=u % n.

To find all intersections, object intersections Array[Array[Int]] of the size n may be considered as intersection matrix n×n; element intersections(i)(j) may contain intersection of Sᵢ and Sⱼ, elements (i)(i) are not yet defined. Since there is single element, Int value is enough, the main diagonal contains only zero.

In the case that |Sᵢ∩Sⱼ|=q+1 (i=j), a mapping θ is built to fill the main diagonal in the intersection matrix. The mapping θ: {Sᵢ}→S is built such that θ(Sᵢ)∈Sᵢ. It can be proven that such mapping always exists. An example mapping is shown below.

### Example 4

$${S}_{0} = \{ ( 0 : 1 : 0 ) , ( 0 : 1 : 1 ) , ( 0 : 0 : 1 ) \} \qquad {p}_{0} = ( 0 , 0 , 1 )$$

$${S}_{1} = \{ ( 1 : 0 : 1 ) , ( 1 : 1 : 1 ) , ( 0 : 1 : 0 ) \} \qquad {p}_{1} = ( 0 , 1 , 0 )$$

$${S}_{2} = \{ ( 1 : 1 : 0 ) , ( 1 : 1 : 1 ) , ( 0 : 0 : 1 ) \} \qquad {p}_{2} = ( 0 , 1 , 1 )$$

$${S}_{3} = \{ ( 1 : 0 : 1 ) , ( 1 : 1 : 0 ) , ( 0 : 1 : 1 ) \} \qquad {p}_{3} = ( 1 , 0 , 0 )$$

$${S}_{4} = \{ ( 1 : 0 : 0 ) , ( 1 : 0 : 1 ) , ( 0 : 0 : 1 ) \} \qquad {p}_{4} = ( 1 , 0 , 1 )$$

$${S}_{5} = \{ ( 1 : 0 : 0 ) , ( 1 : 1 : 1 ) , ( 0 : 1 : 1 ) \} \qquad {p}_{5} = ( 1 , 1 , 0 )$$

$${S}_{6} = \{ ( 1 : 0 : 0 ) , ( 1 : 1 : 0 ) , ( 0 : 1 : 0 ) \} \qquad {p}_{6} = ( 1 , 1 , 1 )$$

As a result, the intersection matrix is obtained as below.

| | 0 | 1 | 2 | 3 | 4 | 5 | 6 |
|---|---|---|---|---|---|---|---|
| 0 | 0 | 1 | 0 | 2 | 0 | 2 | 1 |
| 1 | 1 | 1 | 6 | 4 | 4 | 6 | 1 |
| 2 | 0 | 6 | 5 | 5 | 0 | 6 | 5 |
| 3 | 2 | 4 | 5 | 2 | 4 | 2 | 5 |
| 4 | 0 | 4 | 0 | 4 | 4 | 3 | 3 |
| 5 | 2 | 6 | 6 | 2 | 3 | 6 | 3 |
| 6 | 1 | 1 | 5 | 5 | 3 | 3 | 3 |

It can be seen that each vertex here can not appear more than on q+1=3 partitions (which is the number of equal values in row or column). This is computations for the whole graph. The matrix may be stored for use of graphs with a corresponding number of partitions. The dialog elements correspond to the cases where vertices are mapped to the same line, and other elements correspond to the cases where vertices are mapped to different lines.

Refer back to FIG. 3. The following is the computations for each edge. A given edge 312 is represented as pair of source and destination vertices (u, v). At block 314, find lines for two vertices of the edge. Input of block 314 may comprise IDs of the vertices V of the edge, and output may comprise the indexes of the lines. For example, the mapping ψ: V→{Sᵢ} is defined as the remainder of division of vertex Id by n: ψ(v)=S_{v % n}, ψ(u)=S_{u % n}.

At 316, determine a partition based on the line. In the case v % n=u % n the function Choose P(u, v) from ψ(v)∩ψ(u) is applied. Choose P(u, v) from ψ(v)∩ψ(u) takes element in the place (ψ(v), ψ(u)) from the intersection matrix.

At block 318, a partition result of a the given edge 312 is determined. At block 320, after all edges have been processed, the partitioned graph is output.

FIG. 5 illustrates an example graph for partitioning according to some embodiments of the present disclosure. In FIG. 5, the example vertex IDs are shown in the vertices. It will be appreciated that other IDs are possible.

Consider the graph in FIG. 5. Let P(u, v) be a partition of the edge (u→v). The partition result according to some embodiments of the present disclosure is below.

$${S}_{0} ⋂ {S}_{1} = \{ ( 0 : 1 : 0 ) \} \to P ( 0 , 1 ) = 1$$

$${S}_{0} ⋂ {S}_{3} = \{ ( 0 : 1 : 1 ) \} \to P ( 0 , 3 ) = 2$$

$${S}_{1} ⋂ {S}_{5} = \{ ( 1 : 1 : 1 ) \} \to P ( 1 , 5 ) = 6$$

$${S}_{1} ⋂ {S}_{4} = \{ ( 1 : 0 : 1 ) \} \to P ( 1 , 4 ) = P ( 4 , 1 ) = 4$$

$${S}_{0} ⋂ {S}_{2} = \{ ( 0 : 0 : 1 ) \} \to P ( 2 , 0 ) = 0$$

$${S}_{2} ⋂ {S}_{3} = \{ ( 1 : 1 : 0 ) \} \to P ( 2 , 3 ) = P ( 3 , 2 ) = 5$$

$${S}_{3} ⋂ {S}_{4} = \{ ( 1 : 0 : 1 ) \} \to P ( 3 , 4 ) = 4$$

$${S}_{4} ⋂ {S}_{6} = \{ ( 1 : 0 : 0 ) \} \to P ( 6 , 4 ) = 3$$

The proposed method allows accelerating some graph application. A pipeline is considered where a graph is partitioned before each application run. The method uses relatively fast partitioning process which makes it beneficial in such scenario. Though method is not limited to such scenario, it also can be applicable to the case where partition is performed once and application is performed several times.

In some example embodiments, an apparatus capable of performing the method 200 (for example, the computing device 101) may comprise means for performing the respective steps of the method 200. The means may be implemented in any suitable form. For example, the means may be implemented in a circuitry or software module.

In some example embodiments, the apparatus comprises means for determining, based on a number of partitions of a graph, a plurality of points and a plurality of lines in a finite projective plane, each point corresponding to one of the partitions and each line comprising a subset of the plurality of points; means for determining, based on vertices of each of a plurality of edges of the graph, a first line and a second line of the plurality of lines; means for identifying, based on the first line and the second line, a partition for each edge; and means for partitioning the graph by assigning each edge to a corresponding partition.

In some example embodiments, means for identifying a partition for each edge may comprise means for determining a point in the finite projective plane based on the first line and the second line; and means for determining for the edge a partition corresponding to the point.

In some example embodiments, means for determining a point in the finite projective plane based on the first line and the second line may comprise means for, in response to determining that the first line and the second line are different lines, determining the point as an intersection of the first line and the second line.

In some example embodiments, means for determining a point in the finite projective plane based on the first line and the second line may comprise means for, in response to determining that the first line and the second line are a same line, determining the point as a point in the line based on a mapping from line to point.

In some example embodiments, the apparatus may further comprise means for determining intersections of the plurality of lines; means for determining, based on the mapping, points corresponding to the plurality of lines respectively; and means for storing the determined intersections and points in association with the plurality of lines. In some example embodiments, the mapping may be formed by Kuhn algorithm.

In some example embodiments, the number of the partitions may be a value of an irreducible polynomial of a prime power.

In some example embodiments, the apparatus may further comprise means for obtaining an input number of partitions; and means for determining the number of the partitions as a maximal value equal to or less than the input number of partitions. In some example embodiments, a number of the points and a number of the lines may be equal to the number of the partitions.

In some example embodiments, each line may comprise the prime power plus one. In some example embodiments, each of the points may be represented as an array with three elements of a finite field having an order of the prime power. In some example embodiments, each of the plurality of lines may be defined by one of the points such that all points in the line have a scalar product equal to zero with that point.

In some example embodiments, means for determining a first line and a second line of the plurality of lines may comprise means for determining indexes of the first line and the second line as a function of identities (IDs) of two vertices of the edge, respectively.

In some example embodiments, the function may be defined by a remainder of the ID of a vertex divided by the number of partitions.

In some example embodiments, the apparatus may comprise means for distributing the partitioned graph to multiple computing devices for graph processing.

FIG. 5 illustrates a schematic block diagram of a device 500 that may be used to implement embodiments of the present disclosure. The device 500 may be the device or apparatus described in the embodiments of the present disclosure, such as the computing device 110. As shown in FIG. 5, the device 500 includes a processor 501, which may execute various appropriate actions and processing in accordance with computer program instructions to perform the methods (e.g., the method 200) of the present disclosure. The computer program instructions may be stored in a read-only-memory (ROM) 502 or be loaded onto a random-access-memory (RAM) 503 from a storage unit 508, for example. The processor 501, the ROM 502, and the RAM 503 are connected to each other via bus 504. An input/output (I/O) interface 505 is also connected to bus 504. In addition, although not shown in FIG. 9, the device 500 may also include a co-processor.

A plurality of components in device 500 are connected to the I/O interface 505, including: an input unit 506, such as a keyboard and a mouse; an output unit 507, such as various types of displays and speakers; the storage unit 508, such as a magnetic disk and an optical disc; and a communication unit 509, such as a network card, a modem, and a wireless communication transceiver. The communication unit 509 allows the device 500 to exchange information/data with other devices via a computer network, such as the Internet, and/or various telecommunication networks.

The various methods or processes described above may be performed by the processor 501. For example, in some embodiments, the method may be embodied as a computer software program that is tangibly included in a machine-readable medium, such as in the storage unit 508. In some embodiments, part or all of the computer program may be loaded and/or installed onto the device 500 through the ROM 502 and/or communication unit 509. When the computer program is loaded into the RAM 503 and executed by the processor 501, one or more steps or actions of the methods or processes described herein may be executed.

In some embodiments, the methods and processes described above may be implemented as a computer program product. The computer program product may include a computer-readable storage medium on which computer-readable program instructions for performing various aspects of the present disclosure are loaded.

The computer-readable storage medium may be a tangible device that may retain and store instructions used by an instruction-executing device. For example, the computer-readable storage medium may be, but is not limited to, an electrical storage device, a magnetic storage device, an optical storage device, an electromagnetic storage device, a semiconductor storage device, or any suitable combination of the above. More specific examples (a non-exhaustive list) of the computer-readable storage medium include: a portable computer disk, a hard disk, a RAM, a ROM, an erasable programmable ROM (EPROM or flash memory), a static RAM (SRAM), a portable compact disc ROM (CD-ROM), a DIGITAL VERSATILE DISC (DVD), a memory stick, a floppy disk, a mechanical coding device, for example, a punch card or a raised structure in a groove with instructions stored thereon, and any suitable combination of the foregoing. The computer-readable storage medium used herein is not to be interpreted as transient signals per se, such as radio waves or other freely propagating electromagnetic waves, electromagnetic waves propagating through waveguides or other transmission media (e.g., light pulses through fiber-optic cables), or electrical signals transmitted through electrical wires.

The computer-readable program instructions described herein may be downloaded from a computer-readable storage medium to various computing/processing devices, or downloaded to an external computer or external storage device via a network, such as the Internet, a local area network, a wide area network, and/or a wireless network. The network may include copper transmission cables, fiber optic transmission, wireless transmission, routers, firewalls, switches, gateway computers, and/or edge servers. A network adapter card or network interface in each computing/processing device receives computer-readable program instructions from a network and forwards the computer-readable program instructions for storage in a computer-readable storage medium in each computing/processing device.

The computer program instructions for performing the operations of the present disclosure may be assembly instructions, instruction set architecture (ISA) instructions, machine instructions, machine-related instructions, microcode, firmware instructions, status setting data, or source code or object code written in any combination of one or more programming languages, including object-oriented programming languages as well as other procedural programming languages. The computer-readable program instructions may be executed entirely on a user computer, partly on a user computer, as a stand-alone software package, partly on a user computer and partly on a remote computer, or entirely on a remote computer or a server. In a case where a remote computer is involved, the remote computer can be connected to a user computer through any kind of networks, including a local area network (LAN) or a wide area network (WAN), or can be connected to an external computer (for example, connected through the Internet using an Internet service provider). In some embodiments, an electronic circuit, such as a programmable logic circuit, an FPGA, or a programmable logic array (PLA), is customized by utilizing status information of the computer-readable program instructions. The electronic circuit may execute the computer-readable program instructions so as to implement various aspects of the present disclosure.

These computer-readable program instructions may be provided to a processing unit of a general-purpose computer, a special-purpose computer, or a further programmable data processing apparatus, thereby producing a machine, such that these instructions, when executed by the processing unit of the computer or the further programmable data processing apparatus, produce means for implementing functions/actions specified in one or more blocks in the flow charts and/or block diagrams. These computer-readable program instructions may also be stored in a computer-readable storage medium, and these instructions cause a computer, a programmable data processing apparatus, and/or other devices to operate in a specific manner; and thus the computer-readable medium having instructions stored includes an article of manufacture that includes instructions that implement various aspects of the functions/actions specified in one or more blocks in the flow charts and/or block diagrams.

The computer-readable program instructions may also be loaded onto a computer, other programmable data processing apparatuses, or other devices, such that a series of operating steps may be executed on the computer, the other programmable data processing apparatuses, or the other devices to produce a computer-implemented process, such that the instructions executed on the computer, the other programmable data processing apparatuses, or the other devices may implement the functions/actions specified in one or more blocks in the flow charts and/or block diagrams.

The flow charts and block diagrams in the drawings illustrate the architectures, functions, and operations of possible implementations of the devices, methods, and computer program products according to various embodiments of the present disclosure. In this regard, each block in the flow charts or block diagrams may represent a module, a program segment, or part of an instruction, and the module, program segment, or part of an instruction includes one or more executable instructions for implementing specified logical functions. In some alternative implementations, functions marked in the blocks may also occur in an order different from that marked in the accompanying drawings. For example, two consecutive blocks may in fact be executed substantially concurrently, and sometimes they may also be executed in a reverse order, depending on the functions involved. It should be further noted that each block in the block diagrams and/or flow charts as well as a combination of blocks in the block diagrams and/or flow charts may be implemented using a dedicated hardware-based system that executes specified functions or actions, or using a combination of special hardware and computer instructions.

Various embodiments of the present disclosure have been described above. The foregoing description is illustrative rather than exhaustive, and is not limited to the disclosed various embodiments. Numerous modifications and alterations are apparent to persons of ordinary skill in the art without departing from the scope and spirit of the illustrated embodiments. The selection of terms as used herein is intended to best explain the principles and practical applications of the various embodiments or the technical improvements to technologies on the market, or to enable other persons of ordinary skill in the art to understand the various embodiments disclosed herein.

What is claimed is:

1. A method implemented by a computing device, wherein the method comprises:
obtaining a graph comprising large scale graph data for controlling one or more application systems;
determining, based on a first number of partitions of the graph, a plurality of points and a plurality of lines in a finite projective plane, wherein each point of the plurality of points corresponds to one of the partitions, and wherein each line of the plurality of lines comprises a subset of the plurality of points;
determining, based on vertices of each edge of a plurality of edges of the graph, a first line and a second line of the plurality of lines, wherein the vertices represent items that are linked by the edges, and wherein the edges represent observed events by the one or more application systems;
identifying, using the finite projective plane and based on the first line and the second line, a corresponding partition for each edge of the plurality of edges; and
partitioning the graph by assigning each edge to the corresponding partition.

2. The method of claim 1, wherein identifying the corresponding partition for each edge comprises:
determining a first point in the finite projective plane based on the first line and the second line; and
determining, for each edge, the corresponding partition corresponding to the first point.

3. The method of claim 2, wherein determining the first point in the finite projective plane based on the first line and the second line comprises:
determining that the first line and the second line are different lines; and
determining the first point as an intersection of the first line and the second line.

4. The method of claim 2, wherein determining the first point further comprises:
determining that the first line and the second line are a same line; and
determining the first point as a point in the same line based on a line-to-point mapping.

5. The method of claim 4, further comprising:
determining intersections of the plurality of lines;
determining, based on the line-to-point mapping, second points corresponding to the plurality of lines respectively; and
storing the intersections and second points in association with the plurality of lines.

6. The method of claim 4, further comprising performing the line-to-point mapping using Kuhn algorithm.

7. The method of claim 1, wherein the first number is a value of an irreducible polynomial of a prime power.

8. The method of claim 7, further comprising:
obtaining an input number of partitions; and
determining the first number as a maximal value equal to or less than the input number of partitions.

9. The method of claim 7, wherein each line comprises the prime power plus one.

10. The method of claim 7, wherein each point of the plurality of points is represented as an array with three elements of a finite field having an order of the prime power.

11. The method of claim 10, further comprising defining each line of the plurality of lines by one point of the points such that the plurality of points in the line have a scalar product equal to zero with that one point.

12. The method of claim 1, wherein determining, based on vertices of each edge, a first line and a second line of the plurality of lines comprises determining indexes of the first line and the second line as a function of identities (IDs) of two vertices of each edge, respectively.

13. The method of claim 12, further comprising defining the function by a remainder of a first identifier (ID) of a first vertex divided by the first number of partitions.

14. The method of claim 1, further comprising distributing the graph to multiple second computing devices for graph processing.

15. The method of claim 1, wherein a second number of the points and a third number of the lines are equal to the first number of the partitions.

16. An electronic device, comprising:
a memory configured to store instructions; and
a processor coupled to the memory, wherein when executed by the processor, the instructions cause the electronic device to:
obtain a graph comprising large scale graph data for controlling one or more application systems;
determine, based on a number of partitions of the graph, a plurality of points and a plurality of lines in a finite projective plane, wherein each point of the plurality of points corresponds to one of the partitions, and wherein each line of the plurality of lines comprises a subset of the plurality of points;
determine, based on vertices of each edge of a plurality of edges of the graph, a first line and a second line of the plurality of lines, wherein the vertices represent items that are linked by the edges, and wherein the edges represent observed events by the one or more application systems;
identify, using the finite projective plane and based on the first line and the second line, a partition for each edge; and
partition the graph by assigning each edge to the identified partition.

17. The electronic device of claim 16, wherein, when executed by the processor, the instructions further cause the electronic device to further identify the partition for each edge by:
determining a first point in the finite projective plane based on the first line and the second line; and
determining, for each edge, the partition corresponding to the first point.

18. The electronic device of claim 17, wherein, when executed by the processor, the instructions further cause the electronic device to further determine the first point in the finite projective plane based on the first line and the second line by:
determining the first point as an intersection of the first line and the second line, wherein the first line and the second line are different lines; or
determining the first point as a point in a same line based on a line-to-point mapping, wherein the first line and the second line are the same line.

19. A computer program product tangibly comprising computer-executable instructions that are stored on a non-transitory computer-readable storage medium and that, when executed by a processor, cause a computing device to:
obtain a graph comprising large scale graph data for controlling one or more application systems;
determine, based on a number of partitions of a graph, a plurality of points and a plurality of lines in a finite projective plane, wherein each point of the plurality of points corresponds to one of the partitions, and wherein each line of the plurality of lines comprises a subset of the plurality of points;
determine, using the finite projective plane and based on vertices of each edge of a plurality of edges of the graph, a first line and a second line of the plurality of lines, wherein the vertices represent items that are linked by the edges, and wherein the edges represent observed events by the one or more application systems;
identify, based on the first line and the second line, a partition for each edge; and
partition the graph by assigning each edge to the identified partition.

20. The computer program product of claim 19, wherein when executed by the processor, the computer-executable instructions further cause the computing device to further identify the partition for each edge by:
determining a first point in the finite projective plane based on the first line and the second line; and
determining, for each edge, the partition corresponding to the first point.
